(19) United States
(12) Patent Application Publication
(10) Pub. No.: US 2010/0003661 A1
(43) Pub. Date: Jan. 7, 2010

(54) System for displaying an integrated on-screen product tour on a display

(75) Inventor: Timothy Almeida, Corona, CA (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 12/217,030

(22) Filed: Jul. 1, 2008

(51) Int. Cl. G09B 25/00

(52) U.S. Cl. 434/365

(57) ABSTRACT

A display system for displaying images for an information handling system is disclosed. The display system comprises a housing having a power input and a video signal-receiving connector. A screen is configured to display images based upon a video signal received at the video signal-receiving connector. A processor is configured to cause images to be displayed on the screen. A persistent memory is accessible by the processor. The memory includes a program of instructions for execution by the processor that is configured to cause the screen to display a product tour. The display system includes an initiator configured to initiate the execution of the program of instructions by the processor to display images on the screen, and the initiator may be configured to initiate execution of the program when power is present at the power input and when no signal is detected as being received at the signal receiving connector.

### BACKGROUND

1. Field

The present disclosure relates to video displays and more particularly pertains to a new system for displaying an integrated on-screen product tour on a display for providing an introduction to features of a product that is suited to a retail sales display environment.

2. Description of the Prior Art

Visual display devices for use with information handling system, which are commonly referred to as monitors or displays, are becoming increasingly sophisticated, and with the increased sophistication comes increased capabilities.

As the capabilities of displays increase, it becomes more difficult to provide a potential customer with information about these capabilities in a sales setting, especially a retail store sales setting where employees of the retail store may not be available to provide the potential customer with the desired information regarding all of the capabilities, or may not be aware of all of the capabilities (or may simply forget some of the capabilities). Similarly, after the purchase of the display has been made, the buyer may be challenged by the availability of a plethora of features and capabilities that may not be readily apparent, and may have to be discovered from reading through the often lengthy operation manual for the display.

While this lack of information can be vexing to the user after purchase, at least the user has the option of consulting the operation manual for the information. The lack of information in the retail setting creates a definite disadvantage for creating sales of the display, as the customer then lacks much of the information that would be helpful to comparing models in a particular manufacturer's line or among different manufacturers.

Some attempts have been made to provide at least a portion of this information through printed cards or other fixed displays that may be positioned on or adjacent to the display on the retail shelf, but it is difficult to provide all of the information without taking up valuable shelf space and requiring time-consuming reading through the printed material. Other attempts have involved visual displays on the display itself that are generated from media (such as a CD or DVD) on an attached computer. This may be more effective at dynamically displaying the information, but then requires that each display be connected to a dedicated computer. Thus, while this approach may be taken for one or a few displays for sale in the retail store space, the vast majority of displays will not have this ability to display.

A system has been developed to provide a tour of various product features and capabilities of a display that is incorporated into the display itself, so that the product tour is not received from an outside source and is able to be initiated and run from the display itself. The product tour is interactive, so the tour proceeds at a pace that is comfortable to the customer watching the product tour. However, the known system requires the customer to initiate the product tour.

While the interactive product tour system is highly useful, it could be improved to make the system even more useful, especially in the retail sales environment but also when the user purchases and takes the display home or to the office and needs to operate the display.

### SUMMARY

In view of the foregoing disadvantages inherent in the known types of video displays now present in the prior art, the present disclosure describes a new system for displaying an integrated on-screen product tour on a display which may be utilized for providing an introduction to features of a product that is suited to a retail sales display environment.

The present disclosure relates to a display system for displaying images for an information handling system. The display system comprises a housing having a power input for receiving power from a source external to the housing, and the housing includes a video signal-receiving connector. A screen is mounted on the housing and is configured to display visually-perceptible images based upon a video signal received at the video signal-receiving connector. A processor is mounted on the housing and is configured to cause images to be displayed on the screen. A persistent memory is mounted on the housing and is accessible by the processor. The memory includes a program of instructions for execution by the processor, and the program of instructions is configured to cause the screen to display a product tour. The display system includes an initiator configured to initiate the execution of the program of instructions by the processor to display images on the screen, and the initiator may be configured to initiate execution of the program when power is present at the power input and when no signal is detected as being received at the signal receiving connector.

The foregoing is a general outline of some of the more significant aspects of the invention, and the detailed description of this application that follows discloses additional features of the invention which form the subject matter of the claims appended hereto.

The advantages of the various embodiments of the present invention, along with the various features of novelty that characterize the invention, are disclosed in the following descriptive matter and accompanying drawings.

### BRIEF DESCRIPTION OF THE DRAWINGS

The disclosure will be better understood and when consideration is given to the drawings and the detailed description which follows. Such description makes reference to the annexed drawings wherein:

FIG. 1 is a schematic diagram of the new system according to the present disclosure.

FIG. 2 is a schematic depiction of an exemplary image of the product tour, according to an illustrative embodiment.

FIG. 3 is a schematic depiction of another exemplary image of the product tour, according to an illustrative embodiment.

FIG. 4 is a schematic depiction of another exemplary image of the product tour, according to an illustrative embodiment.

FIG. 5 is a schematic depiction of yet another exemplary image of the product tour, according to an illustrative embodiment.

FIG. 6 is a schematic diagram of one implementation of operation of the display system.

FIG. 7 is a schematic diagram of another implementation of operation of the display system.

### DETAILED DESCRIPTION

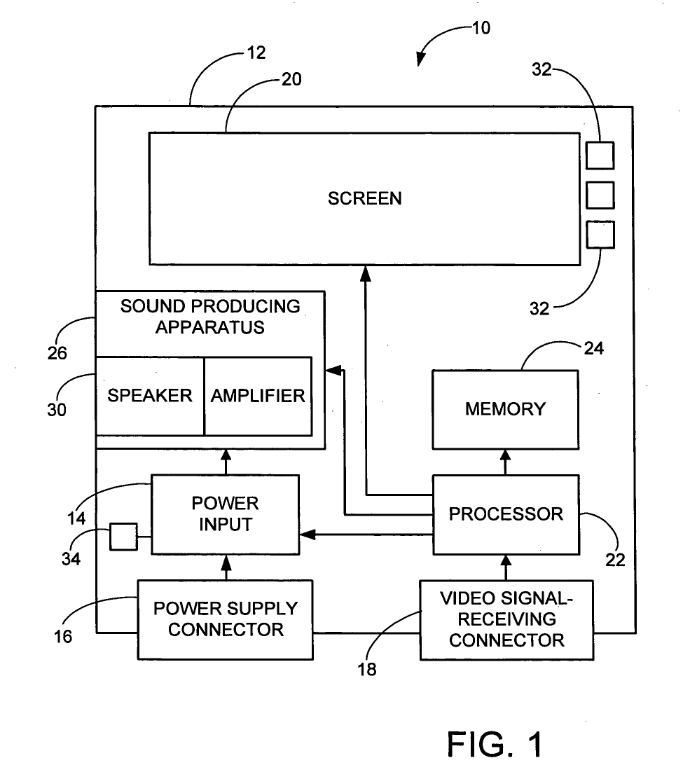

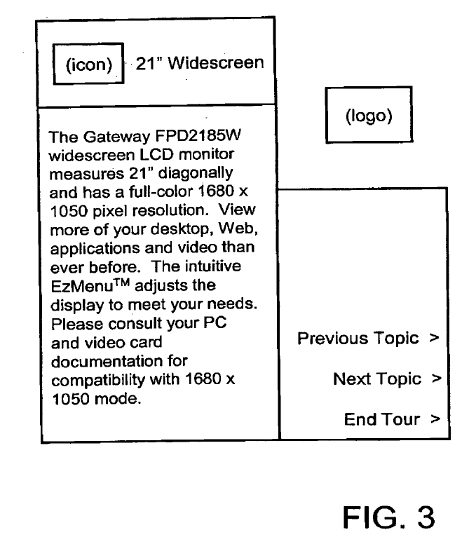

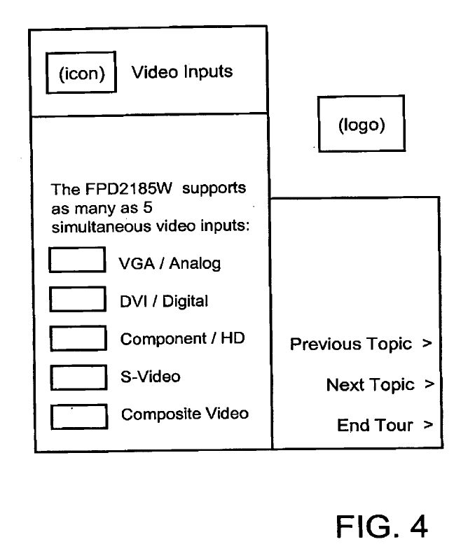

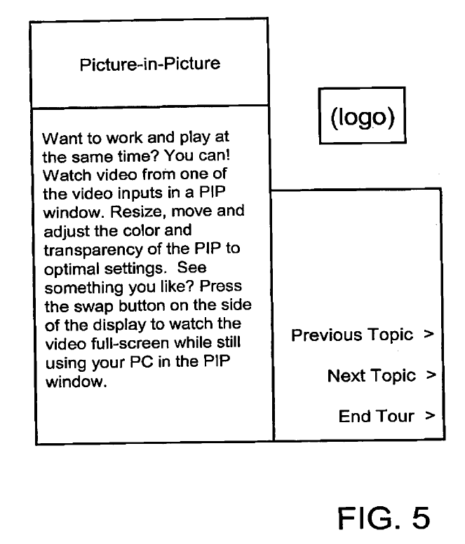

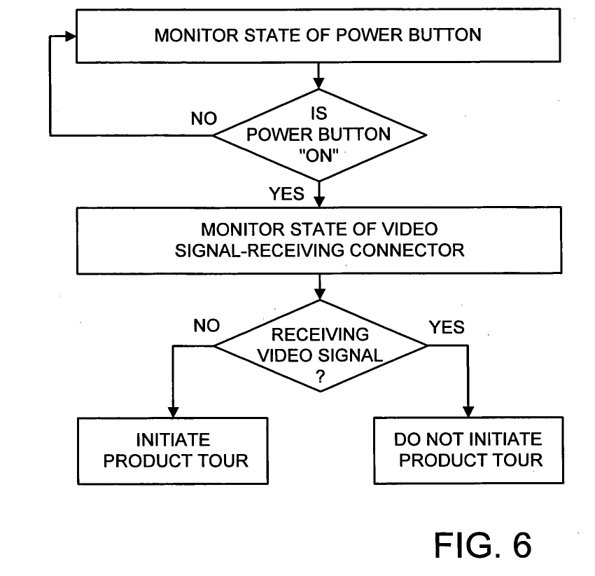

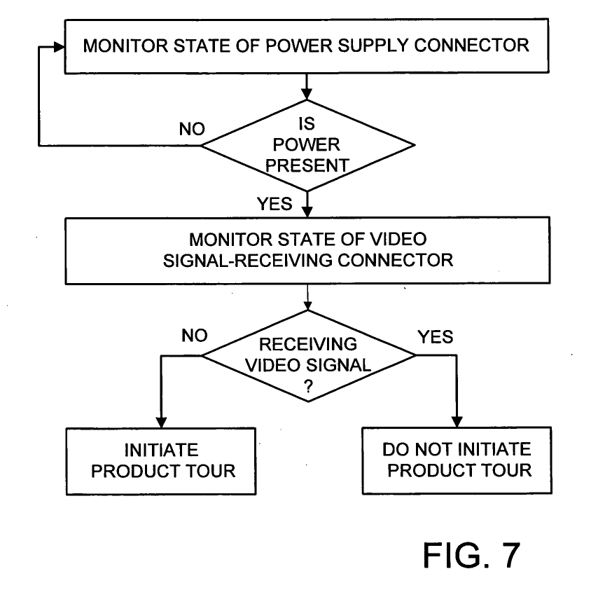

With reference now to the drawings, and in particular to FIGS. 1 through 7 thereof, a new integrated on-screen product tour for displays embodying the principles and concepts of the disclosed subject matter will be described.

This disclosure generally relates to a display system, and is highly suitable for implementation on display systems intended for use with an information handling system, such as a personal computer, but is not so limited and may be used on display system intended for displaying, as an example, television programming. Thus, although the following description may illustratively reference a personal computer system, the disclosure is not so limited and may be employed in virtually any display system or device regardless of the type of device to which it might be connected or to what type of content or images are to be displayed on a screen of the display.

A display system 10 of the disclosure typically includes a housing 12 which defines an interior and houses or encases the other components of the display system. The display system 10 may also include a power input 14 for receiving power from a source external to the housing 12, such as a power cord connected to a power outlet. The power input 14 is typically connected to each of the electronic components of the display system 10 and may supply power to the components to provide power for operation of the components. Often, but not necessarily, the power input 14 has a connector 16 positioned on the exterior of the housing 12 for connection to the power cord, although the power cord may be integrally and inseparably connected to the display housing 12. The housing 12 may also have a video signal-receiving connector 18 that provides an input for video signals from a video signal source such as a computer, or more specifically, the graphics circuitry of the computer. As previously noted, the disclosure is not limited to displays receiving computer-generated video, and thus the signals received through the video signal-receiving connector 18 could be cable, satellite, or over the air signals if the display functions as a television and optionally includes tuning circuitry. The video signal receiving connector 18 may be adapted to conform, for example, to standards or protocols such as, but not limited to, composite video, S-video, component video, DVI video, VGA video, and HDMI video

A screen 20 of the display system 10 is mounted on the housing 12 and is visible from a location exterior of the housing 12. The screen 20 may be configured to display visually-perceptible images based upon a video signal received at the video signal-receiving connector. The screen 20 may incorporate any technology known or developed in the future, including those based upon, for example, a cathode ray tube (CRT) technology, liquid crystal diode (LCD) technology, plasma technology, liquid crystal on silicon (LCOS) technology, as well as others that are known to those skilled in the art.

The display system 10 may also include a processor 22 mounted on or in the housing 12 and may be located in the interior of the housing. The processor may be configured to cause images to be displayed on the screen 20. The technology for producing images by a processor using signals received by the display system 10 at the video signal-receiving connector 18 is known to those skilled in the art.

The display system 10 may include a persistent or non-volatile memory 24 that is mounted on or in the housing 12. The memory 24 is in communication with and is accessible by the processor 22. The memory 24 includes a program of instructions for execution by the processor 22. The program of instructions is adapted or configured to cause (via the processor 22) the screen 20 to display images. The images and the content thereof will be described in greater detail below.

The display system 10 may optionally include a sound producing apparatus 26 that is mounted on or in the housing 12. The sound producing apparatus 26 may be configured to produce audible sounds based upon signals received from the processor 22. The sound producing apparatus 26 may include amplifier circuitry 28 and a sound transducer 30, such as a speaker mounted on the housing 12.

The program of instructions resident on the memory 24 may be directed to a product tour for display on the screen 20. The product tour may include a plurality of images for display on the screen 20 that relate to capabilities of the display system 10. The program of instructions causes the plurality of images to display in a series, and each image may be displayed for a set period of time, or may require the user to press a button on the display system 10 to cause a different image, such as the next image in the series, to be displayed on the screen 20. Optionally, the user may be presented with the option to end the product tour prior to reaching the last image in the series. The product tour of the program of instructions may also include a demonstration of at least one feature of the display system 10. Additionally, the program of instructions may include instructions for causing the processor 22 to send signals to the sound producing apparatus 26 to cause sounds to be emanated from the sound transducer or speaker display system 10 either in connection with, or independent of, the product tour.

The program of instructions, when installed and operating on the processor 22, may operate in an interactive fashion with user-operable elements 32, such as buttons, located on the housing 12 of the display system 10. The user-operable elements 32 may be located adjacent to the screen 20 so that indicia, such as commands or options, may be displayed on portions of the screen adjacent to the elements 32 to thereby associate the commands with the user-operable elements 32 to create a visual association therebetween. The program of instructions may also create a logical association between actuation of the user-operable element 32 on the housing 12 and the action set forth in the command. Illustratively, the commands may include “Next Topic” that when the associated user-operable element 32 is actuated causes the display of the next image in the series of images of the product tour. The commands may also include “Last Topic” that when the associated user-operable element 32 is actuated causes the display of the pervious image in the series of images of the product tour. The commands may further include “End Topic” that when the associated user-operable element 32 is actuated causes the display of the images of the product tour to end, or to return to a first image of the plurality of images of the product tour.

Optionally, other commands may be included, including those that when the associated user-operable element 32 is actuated cause a feature of the display system to be demonstrated. For example, the command may relate to a capability to display the image on the screen 20 in a portrait orientation on the screen 20, and actuation of the user-operable element 32 may cause the displayed image to be rotated, for example, 90 degrees, to demonstrate this capability (and then actuation of the same or other user-operable element 32 could return the display of the image to a landscape orientation).

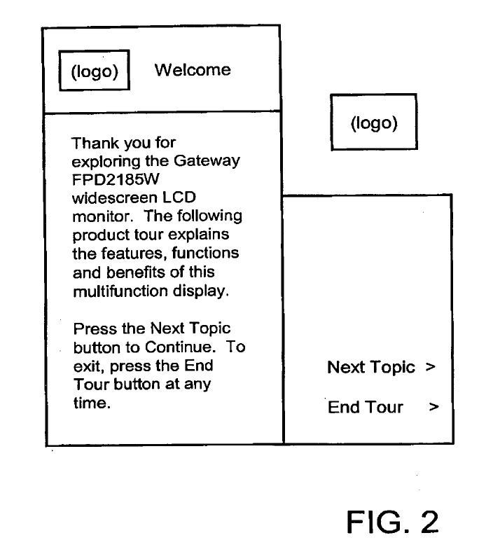

In an illustrative example of the product tour, shown in FIGS. 2 through 5, various images from a product tour for the display system 10 are depicted. Various topics may be discussed, such as an explanation of the product tour, the manner in which the user may navigate through the images of the product tour, the resolution capabilities of the screen 20, the types of inputs available to the display system 10,

A significant aspect of the disclosure is the manner in which the execution of the program of instructions by the processor 22 to display the images on the screen is initiated. In some implementations of the system 10, the display of at least the first image of the product tour on the screen 20 is initiated by the program of instructions upon, or at the time of, the detection of the initial actuation of a power element or button 34 on the housing 12 of the display system 10 that initiates the supply of power from the power connector 16 to the various components of the system 10, including the processor 22, through the power input 14. In some versions of this implementation of the system 10, the initiation of the product tour occurs when the power button 34 is actuated if there is no signal being supplied to the video signal-receiving connector 18 (or to one of a plurality of video signal-receiving connectors 18 if a plurality of video connectors are present in the display system 10). Thus, in this implementation, the product tour will initiate if the display system 10 is powered up but is not attached to a video signal source such as a personal computer, or a video signal source is attached but is not actively providing a video signal to the video signal-receiving connector 18.

In other implementations, the display of at least the first image of the product tour on the screen 20 is initiated by the program of instructions upon, or at the time of, the detection of provision of external power is provided to the power input or supply. (In some versions of this implementation, the display of the first image may be initiated whenever the provision of external power is detected, even if it is not when power is first supplied to the power input 14.) In some of these implementations, the initiation of the product tour occurs when the power is supplied to the power supply connector 16 if there is no signal being supplied to the video signal-receiving connector or connectors 18.

Optionally, the execution of the plurality of instructions and the display of the product tour may not be initiated, or even prevented, if a video signal is detected as being received by the video signal-receiving connector. In other implementations, the execution of the plurality of instructions and the display of the product tour may be initiated and presented if a video signal is not detected at the video signal-receiving connector.

In various implementations, the product tour may proceed by automatically advancing through the images or screens or slides. If one or more of the user-operable elements 32 is actuated while one of the screens of the tour is being presented, the automatic advance of the images through the tour may be interrupted, and the images may be manually advanced by the user by actuating one or more of the user-operable elements. If the user does not actuate one of the elements 32 within a predetermined period of time, (such as, for example, 5 minutes), the automatic presentation of the images may resume either from the image at the point in the tour at which the user stopped actuating the elements 32, or may restart the series of images of the tour from the beginning.

In some implementations, the display of the product tour may be terminated if the user-operable elements 32 are not actuated during a predetermined period of time, such as by stopping display of one of the images, and may not resume the product tour until the actuation of one of the user-operable elements.

It will be appreciated by those skilled in the art that the initiation of the operation of the program may be performed by the processor 22, which is in communication with the video signal-receiving connector 16 and with the power input 14, which is in communication with at least the power supply connector 16 and the power button 34. Optionally, software running on other elements of the display system 10, or hardware present in the display system 10, may be utilized to initiate the execution of the program of instructions.

The implementations of the present disclosure permit the display of an informative product tour in a manner that is highly suitable for use in a retail sales environment in which the display system 10 is displayed but is not necessarily connected to a video source such as a computer. Thus, display systems 10 that are located on shelves displaying a plurality of different displays separate from a computer. The use of the display system with a computer providing video signals, either in the retail space or when the user is using the display system 10 with a computer at home, is not affected by the operation of the product tour since the presence of a video signal may prevent the initiation of the product tour.

The foregoing is considered as illustrative only of the principles of the invention. Further, since numerous modifications and changes will readily occur to those skilled in the art in view of the disclosure of this application, it is not desired to limit the invention to the exact embodiments, implementations, and operations shown and described. Accordingly, all equivalent relationships to those illustrated in the drawings and described in the specification, including all suitable modifications, are intended to be encompassed by the present invention that fall within the scope of the invention.

I claim:

1. A display system for displaying images for an information handling system, comprising:
a housing having a power input for receiving power from a source external to the housing, the housing including a video signal-receiving connector;
a screen mounted on the housing and configured to display visually-perceptible images based upon a video signal received at the video signal-receiving connector;
a processor mounted on the housing and being configured to cause images to be displayed on the screen;
a persistent memory mounted on the housing and being accessible by the processor, the memory including a program of instructions for execution by the processor, the program of instructions being configured to cause the screen to display a product tour; and
an initiator configured to initiate the execution of the program of instructions by the processor to display images on the screen, the initiator being configured to initiate execution of the program when power is present at the power input and when no signal is detected as being received at the video signal-receiving connector.

2. The display system of claim 1 wherein the initiator does not initiate the execution of the plurality of instructions if a signal is detected as being received by the video signal-receiving connector.

3. The display system of claim 1 wherein the product tour of the plurality of instructions includes a plurality of images relating to capabilities of the display system, the product tour including a demonstration of at least one feature.

4. The display system of claim 1 additionally comprising a sound producing assembly mounted on the housing configured to produce audible sounds based upon signals received from the processor, wherein the program of instructions includes instructions for causing the processor to send signals to the sound producing assembly, the sound producing apparatus including amplifier circuitry and a sound transducer.

5. A display system for displaying images for an information handling system, comprising:
a housing having a power input for receiving power from a source external to the housing, the housing including a video signal-receiving connector;
a screen mounted on the housing and configured to display visually-perceptible images based upon a video signal received at the video signal-receiving connector;
a processor mounted on the housing and being configured to cause images to be displayed on the screen;
a persistent memory mounted on the housing and being accessible by the processor, the memory including a program of instructions for execution by the processor, the program of instructions being configured to cause the screen to display a product tour; and
an initiator configured to initiate the execution of the program of instructions by the processor to display images on the screen, the initiator being configured to initiate execution of the program upon the detection of external power being provided to the power input.

6. The display system of claim 5 wherein the initiator does not initiate the execution of the plurality of instructions if a signal is detected as being received by the video signal-receiving connector.

7. The display system of claim 5 wherein the product tour of the plurality of instructions includes a plurality of images relating to capabilities of the display system, the product tour including a demonstration of at least one feature.

8. The display system of claim 5 additionally comprising a sound producing assembly mounted on the housing configured to produce audible sounds based upon signals received from the processor, wherein the program of instructions includes instructions for causing the processor to send signals to the sound producing assembly, the sound producing apparatus including amplifier circuitry and a sound transducer.
